(19) United States
(12) Patent Application Publication
(10) Pub. No.: US 2011/0168620 A1
(43) Pub. Date: Jul. 14, 2011

(54) Apparatus and Method for Coating Diatomaceous Earth Filter Grids

(76) Inventor: Barry Askinasi, Mt. Sinai, NY (US)

(21) Appl. No.: 13/005,690

(22) Filed: Jan. 13, 2011

Related U.S. Application Data
(60) Provisional application No. 61/294,636, filed on Jan. 13, 2010.

(51) Int. Cl. B01D 24/00; G01F 11/00; B01F 5/04

(52) U.S. Cl. 210/233; 210/282; 222/83; 137/599.12

(57) ABSTRACT

A device, method and system for delivering measured amounts of diatomaceous earth into a pool filter system.

### FIELD OF THE INVENTION

The present invention generally relates to pool filters, and more specifically to a method, system and apparatus for coating pool filter grids with diatomaceous earth.

### BACKGROUND OF THE INVENTION

Many choose to swim for recreational and fitness purposes, and thus there are many pools. While a pool can be quite enjoyable, all pools require maintenance to ensure sanitary conditions. An unsanitary pool will support the growth of bacteria and algae, and will result in the spread of diseases and pathogens among users. To maintain sanitary conditions in swimming pools, the water must be continuously or periodically filtered. There are three main types of pool filters currently used for this purpose: sand, cartridge and diatomaceous earth filters.

Of these three filter types, diatomaceous filters are by far the most efficient. Diatomaceous earth filters are able to trap particles as small as 3 to 5 microns in size, while sand filters and cartridge filters are only able to trap particles in the 20 to 100 micron range and in the 25 to 100 micron range, respectively. Diatomaceous earth filters are able to trap particles well smaller than can be seen by the naked eye; they are even able to remove microscopic dust, pollen and other allergens that may be present in the water.

Diatomaceous earth is a widely available, inexpensive powder comprised of the microscopic and chemically inert fossilized remains of diatoms, an ancient type of hard-shelled algae. Composed of microscopically-small, hollow particles which act like tiny sponges, diatomaceous earth is able to trap very fine particles that would otherwise pass through other types of filters. Typically, a diatomaceous earth filter utilizes filter grids covered with a type of fabric. These grids, which are also referred to as elements, septums, fins, tubes, and the like, must be initially coated with diatomaceous earth powder and then recoated each time the filter is backwashed. Backwashing refers to reversing the flow of water through the filter to flush out the accumulated dirt and it must be done approximately once a month to ensure good water quality. This is because, as the filter becomes increasingly clogged up with dirt, the flow rate through the filter decreases and the amount of water that may be effectively filtered diminishes.

Coating a diatomaceous earth filter is currently done by purchasing diatomaceous earth powder and manually pouring a specified amount of the powder either directly into the skimmer or into a separate mixing container with water, which will then be poured into the skimmer. The amount of powder necessary will depend on the size of the filter. After being added to the skimmer, the diatomaceous earth powder will dissolve in the pipe on its way to the filter tank where it will then coat the filter grids.

The current process of coating poses serious health and safety risks. As the diatomaceous earth powder is scooped or poured from its original container into another measuring or mixing container and is then poured into the skimmer, some of the powder is likely to become airborne. This is quite problematic in that the diatomaceous earth powder used in pool filters contains a crystalline form of silica having very sharp edges, the inhalation of which can result in serious damage to the lungs. Inhalation of diatomaceous earth powder can also cause cancer and silicosis, an occupational lung disease characterized by inflammation and scarring of the lungs. Additionally, if not handled with gloves, the absorbent qualities of diatomaceous earth powder will cause significant drying of the hands to occur.

Therefore, it would be advantageous to have a method of replacing the filter medium that would prevent any exposure to the diatomaceous earth powder.

### BRIEF DESCRIPTION OF THE DRAWINGS

The foregoing and other features of the present invention will be more readily apparent from the following detailed description and drawings of illustrative embodiments of the invention in which:

FIG. 1 is a perspective view of the assembled diatomaceous earth filter media replacement cartridge made in accordance with one embodiment of the present invention;

FIG. 2 is an exploded view of the diatomaceous earth filter media replacement cartridge in accordance with one embodiment of the present invention;

FIG. 3 is a bottom view of the assembled diatomaceous earth filter media replacement cartridge in accordance with one embodiment of the present invention;

FIG. 4 is a sectional view showing the inner portion of the diatomaceous earth filter media replacement cartridge being pressed into the outer portion of the diatomaceous earth filter media replacement cartridge;

FIG. 5 is a sectional view of the diatomaceous earth filter media replacement cartridge assembled and activated;

FIG. 6 is a sectional view of a pool skimmer and the placement therein of the diatomaceous earth filter media replacement cartridge in accordance with one embodiment of the present invention;

FIG. 7 is an exploded view of the diatomaceous earth filter media replacement cartridge in accordance with another embodiment of the present invention;

FIG. 8 is an exploded view of an embodiment of an in-line injection unit for receiving the diatomaceous earth filter media replacement cartridge;

FIG. 9 is an exploded view of another embodiment of an in-line injection unit for receiving the diatomaceous earth filter media replacement cartridge; and

FIG. 10 is a perspective view of the in-line injection unit installed in a filtering system for a pool.

### DETAILED DESCRIPTION OF THE PREFERRED EMBODIMENTS

Various embodiments now will be described more fully hereinafter with reference to the accompanying drawings, which form a part hereof, and which show, by way of illustration, specific embodiments. However, this invention may be embodied in many different forms and should not be construed as limited to the embodiments set forth herein. Rather, these embodiments are provided so that this disclosure will be thorough and complete, and will fully convey the scope of the invention to those skilled in the art. The following detailed description is not to be taken in a limiting sense.

Throughout the specification and claims, the following terms take the meanings explicitly associated herein, unless the context clearly dictates otherwise. The phrase “in one embodiment” does not necessarily refer to the same embodiment, although it may. Furthermore, the phrase “in another embodiment” does not necessarily refer to a different embodiment, although it may. Thus, as described below, various embodiments of the invention may be readily combined without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

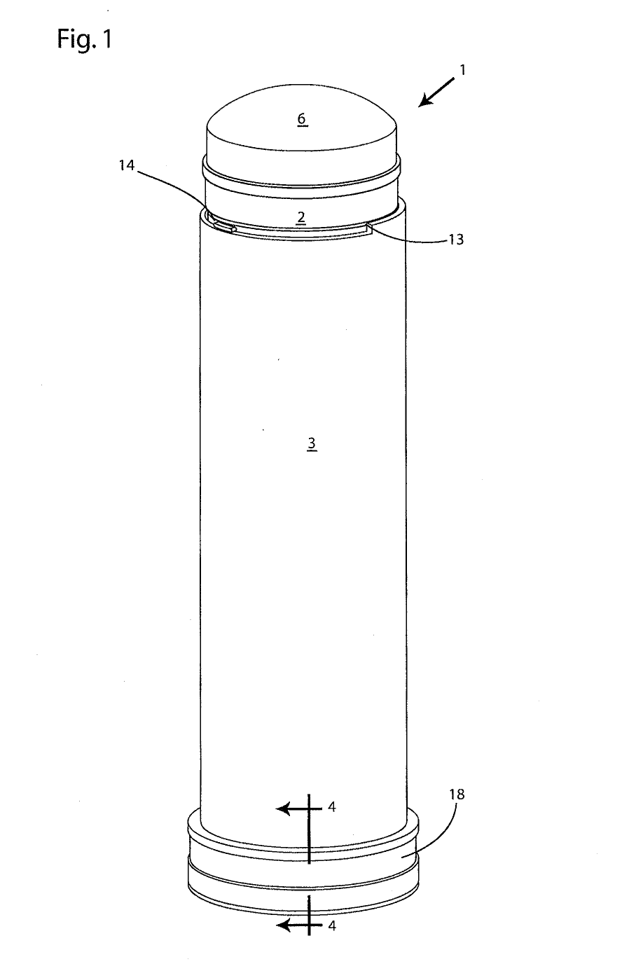

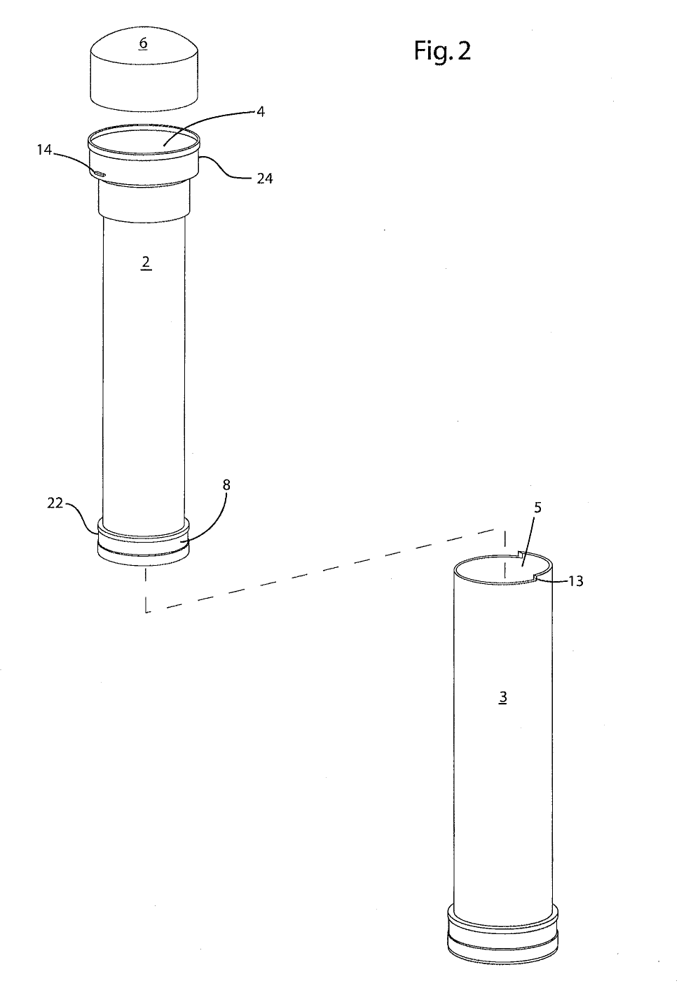

Referring now to FIGS. 1-5, diatomaceous earth filter media replacement cartridge 1 is comprised of a holder or inner portion 2, and an outer portion 3. The holder 2 and outer portion 3 each have interior cavities 4 and 5, respectively, and are preferably, although not necessarily, in the shape of a canister or tube. The holder 2 and outer portion 3 may be made of plastic, and in one embodiment are PVC, but they can be made of suitable materials other than plastic. As one example, the holder and outer portion may be made of a stiff cardboard or paper substance, which may be disposable. The interior cavity 5 of the outer portion 3 is sized to slidably receive the holder 2. The interior cavity 4 of holder 2 contains a predetermined amount of diatomaceous earth powder 7. The bottom of holder 2 may be additionally provided with a gasket 8 that is located around lower portion 22 of holder 2. Gasket 8 is preferably rubber to seal the holder 2 within interior cavity 5 of outer portion 3, thus preventing diatomaceous earth 7 from escaping back up towards the top of the cartridge when the seal 10 is punctured.

The diatomaceous earth powder 7 is poured or injected into the interior cavity 4 of holder 2, after which the cap 6 is attached. This step is preferably performed during the manufacture of the cartridge 1, prior to the end user receiving it so as to ensure that end users are not exposed to the health risks caused by airborne diatomaceous earth powder.

The holder 2 is received into outer portion 3. The outer diameter of the lower portion 22 is such that is can be slidably received into the interior cavity 5 of the outer portion 3. The outer diameter of the lower portion 22 may be dimensioned such that there is a close fit between the inner diameter of the outer portion 3, which can further reduce the chance of diatomaceous earth 7 from escaping back up towards the user when the seal 10 is punctured. The upper portion 24 of holder 2 may have a diameter larger than the inner diameter of outer portion 3.

The cap 6 may be received into upper portion 24. The cap 6 may be affixed by means such as welding or gluing, or may be removably attached by means such as threading, snap fit or tight-fit. The former would prevent end users from being able to become exposed to the diatomaceous earth powder 7, while the latter would make it somewhat easier for the manufacturer to refill used cartridges 1 with diatomaceous earth powder 7 so that they may be reused. Cap 6 may be made of the same material as holder 2 or of another suitable material and can be any shape so long as it covers the top of interior cavity 4. In yet another embodiment, cap 6 may be integral with holder 2 and interior cavity 4 may be filled from the opposite end which is then sealed as described herein.

At the bottom of the interior cavity 4 of holder 2 is first aperture 9 covered by seal 10 which is affixed to holder 2, at the bottom edge or at gasket 8. Seal 10 may be mechanically attached, such as by glue, or may be held in place between the gasket 8 and the holder 2. Seal 10 operates to retain diatomaceous earth powder 7 within interior cavity 4 prior to discharge into the filter. Seal 10 could be made out of any number of materials, such as metal foil (e.g. aluminum), plastic, rubber, paper or cardboard.

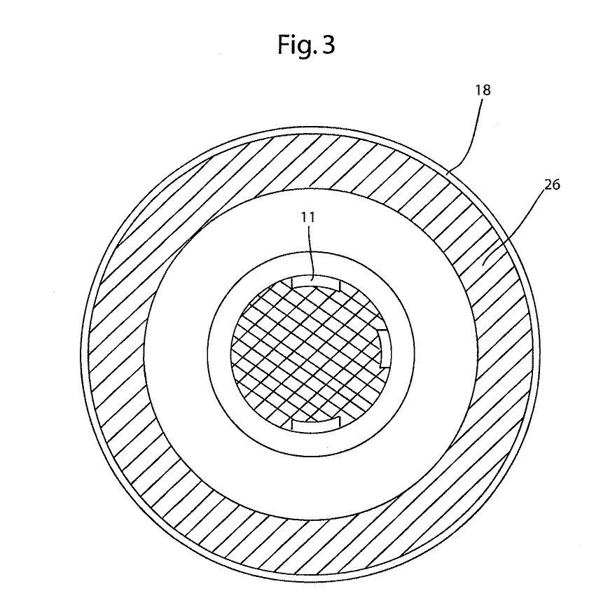

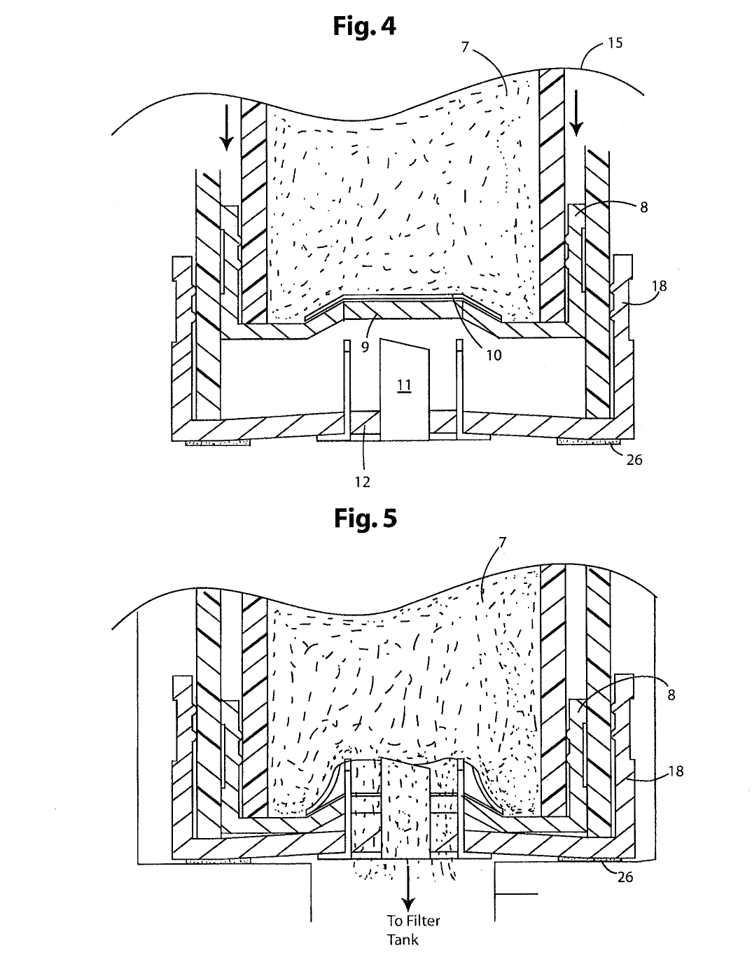

At the bottom of interior cavity 5 of outer portion 3 is second aperture 12. Disposed at the periphery of the second aperture 12 are three fins or cutting elements 11. Second aperture 12 may be sized just smaller than first aperture 9 such that the fins 11 will slide in at the periphery of the first aperture 9 when the cartridge I is engaged. The first and second apertures 9 and 12 can be any shape, though they are preferably circular. Similarly, fins 11 may be any protrusion that is able to puncture the seal 10. The fins 11 may be formed from a small piece of tube or flange (e.g. PVC flange) which is cut so that three fins 11 are provided to puncture seal 10. As can been seen in FIG. 3, fins 11 are curved which allows them to more easily rotate within circular aperture 9 when seal 10 is punctured. The tops of fins 11 may be angled, as can be seen in FIG. 4, so that the may more easily puncture seal 10. Further, the thickness along the puncturing edge of fins 11 may be reduced and cut on a bias to form a blade-like edge, which will also assist in puncturing the seal. The fins can be other suitable shapes or numbers, and can be made from other suitable materials.

Outer gasket 18, which is similar to gasket 8, is shown at the bottom of the outer portion 3, which covers the bottom of interior cavity 5. Outer gasket 18 may provide a point of attachment for the fins 11. Alternatively, the bottom of the outer portion 3 could be one solid piece or a separate piece containing second aperture 12 and at least one fin 11 which could be removably or permanently affixed. Outer gasket 18 may also contain sealing gasket 26 which provides an additional sealing capability when the cartridge is in use.

The cartridge 1 may be packaged and provided to users in two pieces, holder 2 and outer portion 3, or as a single piece with the holder 2 slidably retained within the outer portion 3. If the latter is provided, there must be additional measures provided to ensure that the seal 10 is not broken until the user desires to discharge the diatomaceous earth powder 7 into the pool filter. This could be accomplished by providing a block or stop within the interior cavity 5 that would be removed by the user prior to use, by utilizing a slot and notch in the sidewalls of the inner and outer portions 2 and 3 such that the seal 10 is held above the fins 11 or by making the bottom of the outer portion 3 a removable piece to be attached by the user prior to use. Holder 3 may also have a removable cap over it, which protects the seal during shipment and handling, but would be removed by the user prior to use. Any of countless methods of preventing the puncture of seal 10 before the user desires could be used so that the cartridge 1 may be provided to the user in one rather than two pieces.

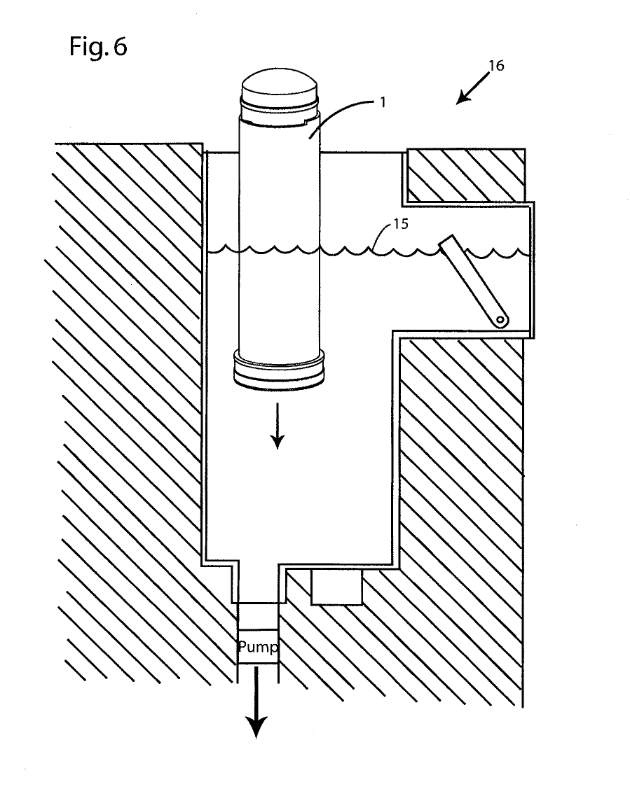

Referring now to FIGS. 4-6 illustrating the use of the cartridge 1, the outer portion 3 is placed into a pool skimmer 16 preferably at a sufficient depth such that the top of the fins 11 are below the water line 15 which will ensure that none of the diatomaceous earth powder 7 can become airborne. It is further desirable to place the outer portion 3 into the skimmer 16 such that the pipe leading to the pool filter is directly beneath the second aperture 12 to ensure that the diatomaceous earth powder 7 will be pulled by the water pump directly into the filter tank and will not dissolve and remain in the skimmer 16. To activate the cartridge 1, holder 2 is then pressed or allowed to slide downwards into the outer portion 3. At least one fin 11 will puncture the seal 10 (FIG. 5). Once the cartridge 1 is fully engaged, which occurs when the bottom of holder 2 engages the bottom of outer portion 3 or stop 14 engages the top of outer portion 3, the user then rotates either the inner or outer portions 2 or 3. This relative rotation will cause the fins 11 to tear open the seal 10 at which point the diatomaceous earth powder 7 will exit through the first aperture 9 and travel through the second aperture 12 downwards towards the filter tank. Once enough time has elapsed to allow all of the diatomaceous earth powder 7 to leave the cartridge 1, it can be removed.

A stop 14 may be provided on upper portion 22 and a stepped-up portion 13 may be provided on the outer portion 3 to prevent the inner and outer portions 2 and 3 from making a full rotation with respect to each other. This will prevent the fins 11 from making a full rotation and completely separating seal 10. In other words, it is desired to tear seal 10 so as to create a flap through which the diatomaceous earth powder 7 may flow. If seal 10 is fully torn around the periphery of aperture 9, seal 10 would be torn free and may be pumped into the filter tank along with diatomaceous earth powder 7.

Furthermore, while it is shown that gasket 8 contains recessed portions between the first aperture 9 and the exterior walls of the holder 2, alternative embodiments are contemplated wherein the bottom of holder 2 is either flat or has inclined walls such that the diatomaceous earth powder 7 is funneled towards first aperture 9. This will ensure that as much of the diatomaceous earth powder 7 as possible will exit the cartridge 1 and head towards the pool filter.

After the cartridge 1 has been used, it may be disposed of. It may also be sent back to the manufacturer to be refilled. Both holder 2 and outer portion 3 may be sent back, though it is only necessary to send back holder 2. The user may retain outer portion 3 to be used again with a new or refilled holder 2.

In an alternative embodiment, outer portion 3 may contain apertures along its periphery at the bottom in or near outer gasket 18 to permit water to flow into the interior of outer portion 3 and down through second aperture 12 and to the pool filter. The fins may be configured so as to direct the inflowing water upwards into interior cavity 4. The water would then collect diatomaceous earth 7, pass back through first aperture 9, second aperture 12 and to the pool filter.

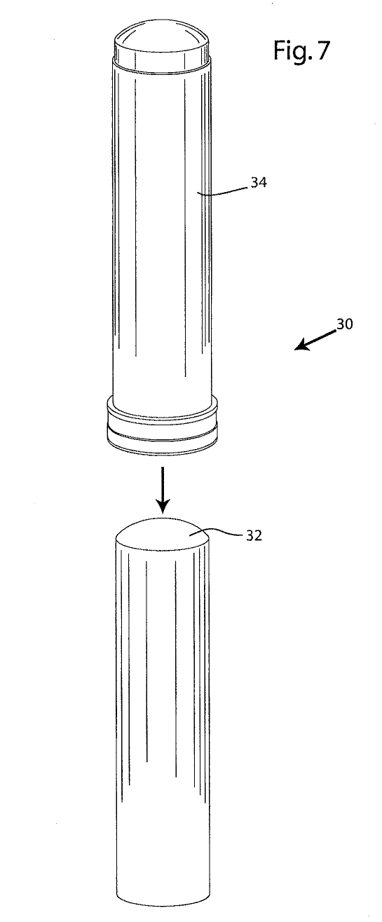

Another alternative embodiment of the diatomaceous earth filter cartridge is shown in FIG. 7. In this alternate embodiment, DE filter media replacement cartridge 30 is comprised of inner refill canister 32 which is inserted into outer canister 34. Inner refill canister 32 may be locked into place within outer canister 34 in a number of manners or may only be in a slide fit engagement. The lower portion of inner refill canister 32 may contain a seal similar to that shown in FIG. 4. In yet another alternative embodiment, the refill canister may consist of a single canister with a sealed end. In this embodiment, the sealed end may be protected from rupturing during shipment or handling by having a cap protector that is screwed, snap fit or other suitable method of attachment over the end having the seal.

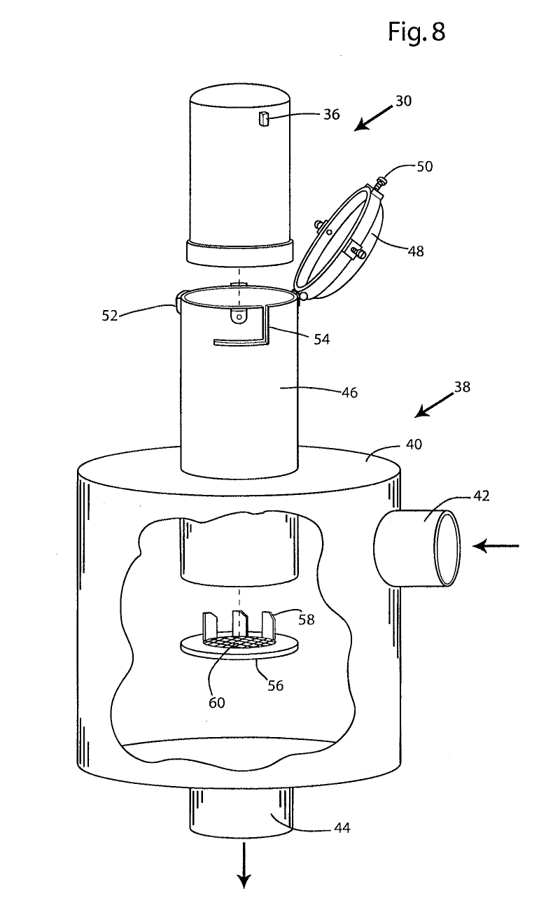

An inline injection unit 38, within which DE filter media replacement cartridge 30 is used, is shown in FIG. 8. Inline injection unit 38 is comprised of body 40 with an inlet 42 which is connected via hoses to the pool and an outlet 44 that is connected via hoses to the pool filter. Water travels from the pool through the hoses or lines into inlet 42 through body 40 out of outlet 44 and then to the pool filter. Disposed also on body 40 is drop shoot 46 within which DE filter replacement cartridge 30 may be inserted. On the lower end of drop chute 46 is built in cutter 56 which is comprised of cutting teeth 58 and mesh 60. At an opposing end of drop chute 46 is lid 48 with screw tie downs 50 that are positioned to engage screw receivers 52 when lid 48 is in the closed position over drop chute 46. Any other alternative means of holding lid 48 fast on top of drop chute 46 may be used, including clamps, brackets, snap fit and any other methods. In one embodiment, DE filter replacement cartridge 3.0 may have notch 36 located on its upper end. When replacement cartridge 30 is inserted into drop chute 46, notch 30 may engage drop notch slot 54. Drop slot notch 54 may be an L shaped slot within drop chute 46 so that the filter replacement cartridge must be lowered straight into drop chute 46 and then rotated for drop notch 36 to fully engage drop notch slot 54. This action of vertically inserting replacement cartridge 30 into drop chute 46 will cause the bottom seal of replacement cartridge 30 to be penetrated by cutters 58. When the replacement cartridge is rotated within drop chute 46, cutters 58 will further cut the foil on the lower end of replacement cartridge 30 and allow water travelling through body 40 to come in contact with the diatomaceous earth located within replacement cartridge 30. Mesh 60 may be used to keep the diatomaceous earth from leaving replacement cartridge 30 at too high of a rate. Mesh 60 may also be sized so as to provide a time delay effect, for example if a material such as chlorine or other pool maintenance chemicals are being dispensed, other than diatomaceous earth. In such an embodiment, an indicator may be incorporated into either the in-line injection unit and/or the replacement cartridge. For example, the drop shoot and cartridge may contain a transparent section so that the user can determine the amount of material remaining.

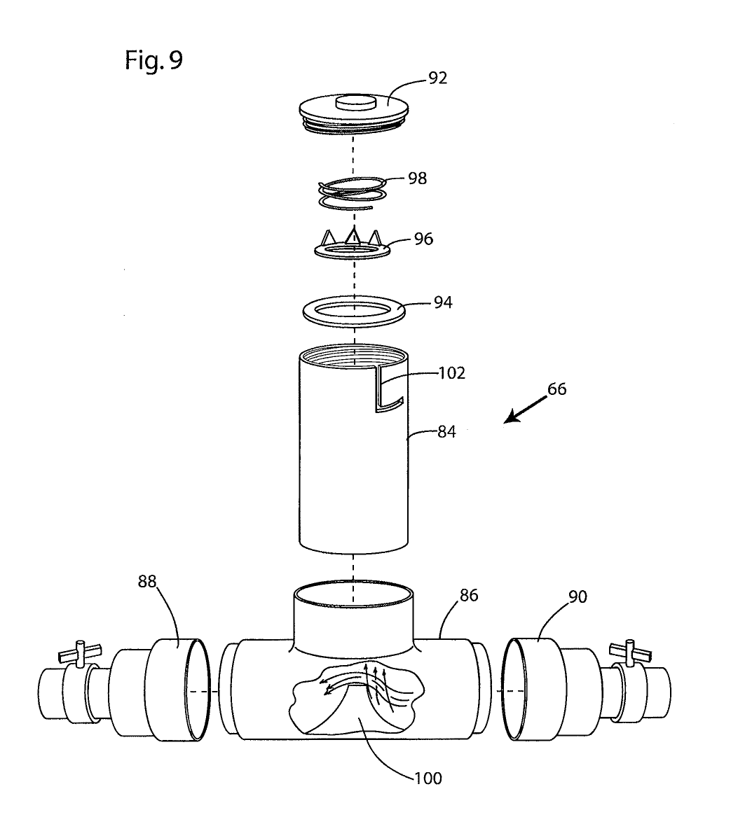

Another embodiment of inline injection unit is shown in FIG. 9. Inline injection unit 66 is comprised of three-way pipe 86 onto which drop chute 84 is connected at one of the sections. On one end of the three way pipe is inlet 90 that may be comprised of a mating piece and a valve. On the other end of the three way pipe is outlet 88 which also may be comprised of a mating piece and a valve. Water from the pool will travel through inlet 90, the bottom of three way pipe 86, part of it may travel up towards drop chute 84, and then continue through outlet 88 to the pool filter. Drop chute 84 works in a similar manner to drop chute 46 of FIG. 8. In this instance, drop chute 84 contains drop notch slot 102 which is configured to engage notch 36 of replacement cartridge 30. Drop chute 84 is sealed through cap 92, in this instance a screw fit top. Within drop chute 84 is placed cut plate 94, cut teeth 96 and spring 98. Cut plate 94 may have a mesh along the interior of it and may be made an integral part of drop chute 84 or as a separate piece that is connected and/or removably connected to the bottom of drop chute 84. Cut teeth 96 are placed on top of cut plate 94 so that when replacement cartridge 30 is inserted into drop chute 84 and lowered to its bottom position, cut teeth 96 engage with the foil seal on the bottom of replacement cartridge 30 to enable access of flowing water into replacement cartridge 30. Spring 98 will enable the biasing of replacement cartridge 30 in the upwards direction out of drop chute 84 so as to assist in the removal of replacement cartridge 30 when it is spent.

In operation, a user may shut off inlet 90 temporarily while using the unit. Next, the user will unscrew cap 92 and insert replacement cartridge 30 into drop chute 84, notch 36 will engage with drop notch slot 102 until replacement cartridge 30 is in its lowest position. Cut teeth 96 will first puncture the seal on the lower end of replacement cartridge 30. The user will be required to use extra force to put it into its lowest position because the cartridge is being biased against spring 98. When the cartridge reaches the lowest position, the user rotates the cartridge, in this instance in a counterclockwise direction, so that notch 36 follows the lower end of drop notch slot 102. This action will cause cut teeth 96 to further cut the foil on the lower portion of replacement cartridge 30. Now, the diatomaceous earth material may begin falling out of DE replacement cartridge 30. The user would then open inlet 90 so that water may begin flowing through t-shaped pipe 86 to outlet 88. In one embodiment, insert 100 is placed below drop chute 84 so as to create turbulence within the water flow thereby causing the water to flow upwards and into drop chute 84, and thereby into replacement cartridge 30, for further helping the diatomaceous earth to flow out of replacement cartridge 30.

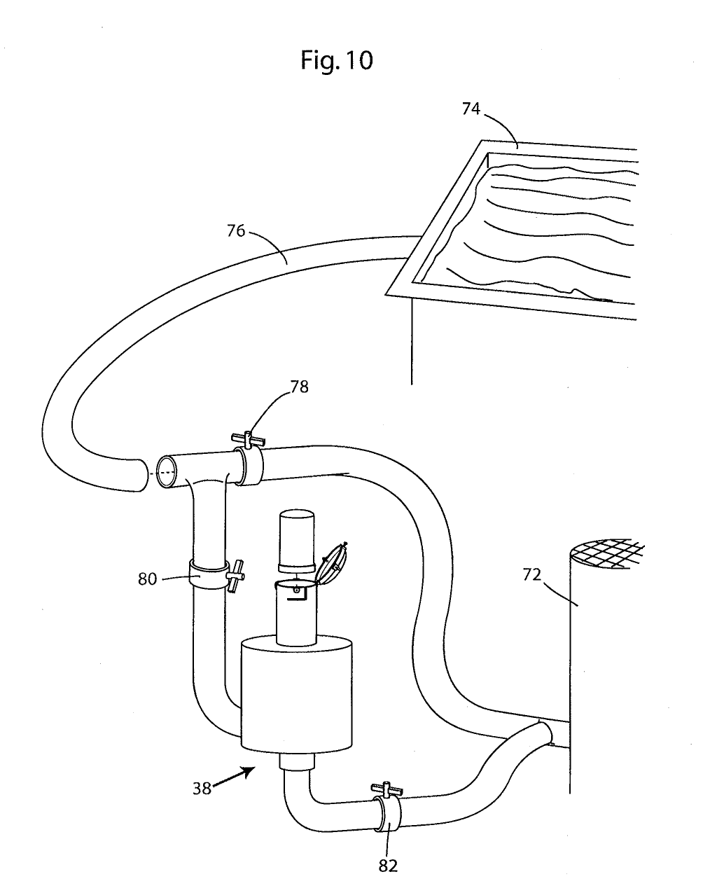

FIG. 10 shows the placement of an inline injection unit within a pool system. Inline injection unit 38 is placed between valves 80 and 82 as an offshoot of line 76 which extends from pool 74 to pool filter 72. To operate inline injection unit 38 after placement of replacement cartridge 30 within the unit, the user may open valves 80 and 82 and close valve 78. This would cause water to divert through inline injection unit 38 to pool filter 72.

As apparent, the purpose of this inline setup is the controlled application and diffusion of diatomaceous earth into the desired water filtering system of the pool. With this setup, the consumer's direct contact with the diatomaceous earth is limited. The design and apparatus allows for a predetermined store-bought of diatomaceous earth to be administered in a controlled fashion.

The unit can be used in any residential or commercial setup. It is compatible with any filter setup that has room to accommodate its size and function. The device ultimately cuts down on application time and exposure to the diatomaceous earth. It can also have a positive effect on any potential clogging and cleanup.

The invention may also have application beyond the release of diatomaceous earth. As one example, the cartridge may contain chlorine or other chemicals that are periodically introduced into the pool for maintenance. The cartridge may come in various sizes to correspond to various sizes of respective pools, As another example, the application of the material from the cartridge may be time-released by altering the size of the screen within the in-line injection unit.

While the invention has been particularly shown and described with reference to preferred embodiments thereof, it will be understood by those skilled in the art that various changes in form and details may be made therein without departing from the spirit and scope of the invention.

1. A diatomaceous earth filter media replacement cartridge comprising:
a canister having a closed proximate end and an open distal end;
diatomaceous earth contained within the canister; and
a punctureable seal over the open distal end of the canister for containing the diatomaceous earth within the canister.

2. The replacement cartridge of claim 1, further comprising:
an outer section that is slidably engageble with the canister;
the outer section having proximate and distal ends, with the proximate end being open for receiving the canister and the distal end having an aperture; and
at least one cutting element at the distal end of the outer section for puncturing the seal over the distal end of the canister when the canister is inserted into the outer section.

3. The replacement cartridge of claim 1, further comprising:
a gasket seal at the proximate end of the canister for sealing contact with an interior of the outer section.

4. The replacement cartridge of claim 2, further comprising:
a stop piece on the canister and a stepped-up portion at the proximate end of the outer section for preventing full rotation of the replacement cartridge within the outer section.

5. The replacement cartridge of claim 1, further comprising:
a removeable cover disposed over the distal end of the canister for protecting the puncturable seal during shipment.

6. The replacement cartridge of claim 1, wherein the proximate end of the canister is removably closed.

7. The replacement cartridge of claim 1, further comprising:
a means for in-line injection of diatomaceous earth from the canister to a pool filtering system by puncturing the seal.

8. A method of dispensing diatomaceous earth within a pool comprising:
placing a distal end of an outer section over an outlet of a skimmer of the pool, the distal end of the outer section having an aperture;
inserting a holder into an open proximate end of the outer section, the holder including,
a canister having a closed proximate end and an open distal end;
diatomaceous earth contained within the canister; and
a punctureable seal over the open distal end of the canister for containing the diatomaceous earth within the canister;
rotating the holder relative to the outer section to cause a cutting element to cut the seal and dispense the diatomaceous earth.

9. A system of dispensing diatomaceous earth within a pool comprising:
a holder including,
a canister having a closed proximate end and an open distal end;
diatomaceous earth contained within the canister; and
a punctureable seal over the open distal end of the canister for containing the diatomaceous earth within the canister;
an in-line injection unit having,
an inlet coupled to the pool;
an outlet coupled to a pool filter;
a drop shoot coupled between the inlet and outlet and configured to receive the canister;
the drop shoot having a first and second end, with the first end having a closeable lid and the second end having an aperture in fluid contact with the inlet and outlet;
the drop shoot having a cutting element located proximate the second end;
wherein when the holder is inserted into the drop shoot, the cutting element punctures the seal over the distal end of the canister and dispenses the diatomaceous earth from the canister through the outlet and into the pool filter.

10. The system of claim 9 wherein the holder contains a notch that engages a notch slot in the drop shoot so as to limit the movement of the holder within the drop shoot.
